(19) United States
(12) Patent Application Publication
(10) Pub. No.: US 2014/0195502 A1
(43) Pub. Date: Jul. 10, 2014

(54) MULTIDIMENSION COLUMN-BASED PARTITIONING AND STORAGE

(71) Applicants: Wei Huang, Los Altos, CA (US); Yizheng Zhou, Cupertino, CA (US); Bin Yu, San Ramon, CA (US)

(72) Inventors: Wei Huang, Los Altos, CA (US); Yizheng Zhou, Cupertino, CA (US); Bin Yu, San Ramon, CA (US)

(21) Appl. No.: 14/237,280

(22) PCT Filed: Aug. 24, 2012
(86) PCT No.: PCT/US2012/052284

§ 371 Date: Feb. 5, 2014

Related U.S. Application Data
(60) Provisional application No. 61/527,982, filed on Aug. 26, 2011.

(51) Int. Cl. G06F 17/30

(52) U.S. Cl. CPC G06F 17/30292; G06F 17/30153; G06F 17/30424
USPC 707/693; 707/803; 707/769

(57) ABSTRACT

A data storage system includes a storage engine to partition data across multiple dimensions. The storage engine determines chunks according to the partitioning, and performs column-based storage of the chunks.

### CLAIM FOR PRIORITY

The present application claims priority to U.S. Provisional application No. 61/527,982, filed on Aug. 26, 2011, which is incorporated by reference herein in its entirety.

### BACKGROUND

It can be challenging to manage storing and querying data in a traditional relational database management system (ROWS). In many environments, which may include environments with large amounts of data, a skilled database administrator (DBA) may often try to tune the database, such as adding indices, to improve query performance.

### BRIEF DESCRIPTION OF DRAWINGS

The embodiments are described in detail in the following description with reference to the following figures. The figures illustrate examples of the embodiments.

FIG. 1 illustrates a data storage system.

FIG. 2 illustrates a security information and event management system.

FIGS. 3 and 4 illustrate methods.

FIG. 5 illustrates a computer system that may be used for the methods and systems described herein.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an embodiment, a data storage system partitions data into chunks and the data in the chunks is stored by column, for example, in compressed form to conserve storage space. A chunk is a portion of data in a column. A column may be a field in an event schema for event data. A query may be executed on the column-stored data by identifying chunks and columns relevant for the query. The chunks, if previously compressed, are decompressed and concatenated, and the query may be executed on the concatenated chunks.

An example of the type of data stored in the data storage system is real-time event data, however, any type of data may be stored in the data storage system. The event data may be correlated and analyzed to identify security threats. A security event, also referred to as an event, is any activity that can be analyzed to determine if it is associated with a security threat, and the event data may include data associated with the security event. The activity may be associated with a user, also referred to as an actor, to identify the security threat and the cause of the security threat. Activities may include logins, logouts, sending data over a network, sending emails, accessing applications, reading or writing data, etc. A security threat may include activities determined to be indicative of suspicious or inappropriate behavior, which may be performed over a network or on systems connected to a network. A common security threat, by way of example, is a user or code attempting to gain unauthorized access to confidential information, such as social security numbers, credit card numbers, etc, over a network.

The data sources for the events may include network devices, applications or other types of data sources described below operable to provide event data that may be used to identify network security threats. Event data is data describing events. Event data may be captured in logs or messages generated by the data sources. For example, intrusion detection systems (IDSs), intrusion prevention systems (IPSs), vulnerability assessment tools, firewalls, anti virus tools, anti-spam tools, and encryption tools may generate logs describing activities performed by the source. Event data may be provided, for example, by entries in a log file or a syslog server, alerts, alarms, network packets, emails, or notification pages.

Event data can include information about the device or application that generated the event. The event source is a network endpoint identifier (e.g., an IP address or Media Access Control (MAC) address) and/or a description of the source, possibly including information about the product's vendor and version. The time attributes, source information and other information is used to correlate events with a user and analyze events for security threats.

The data storage system provides high-performance, and high-efficiency, read-optimized storage (ROS). Query performance may be improved by using column-based storage and by executing a query on chunks determined to be relevant to the query rather than executing the query on all the stored data or a larger subset of the data. The data storage system may also archive in ROS to maximize efficiency for data storage.

The data storage system may store event data for millions or billions of events. It's challenging to store billions of security events in traditional relation databases and query execution can be slow for large amounts of event data. The data storage system may group thousands events into a batch, and then vertically partitions the batch to n ROS chunks (a chunk maps to a column). After encoding and compression, the chunks, which are just fractional of original data size, may be persisted in the data storage. Since the compression is so efficient, it significantly minimizes input/output resource consumption. Also, the data storage system can sustain billions of events without complicated partition management. The chunk-based dynamic partitioning performed by the data storage system is simple, adaptive and extendible.

In one example, the data storage system performs two-phase query execution. The first phase is a fussy search that narrows down where the possible hits are, For example, metadata for each chunk is used to identify chunks that may store data for the query. The second phase is filtering, using fast scan technology to filter and find the matching events. Also, in one example, all columns are indexed, so query performance is improved. For example, an event data schema may have many different columns and each column may be indexed.

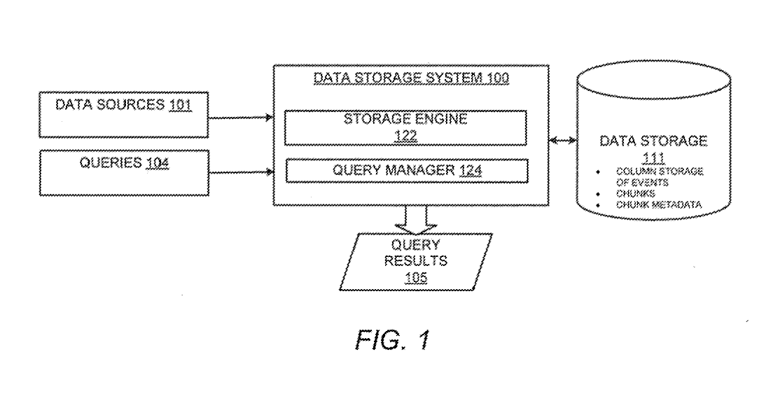

FIG. 1 illustrates a data storage system 100 comprising a storage engine 122 and query manager 124. The storage engine 122 performs multidimensional data partitioning of data, which may be event data, received from data sources 101. The data sources 101 may comprise a network device, an application or other type of system that can provide data for storage in the data storage system 100. A dimension for the multidimensional data partitioning may be a field or an attribute for the data. The dimension may be a field/column in an event data schema. The storage engine 122 may be optimized for extremely high event throughput. The storage engine 122 stores data in the data storage 111, for example in compressed form. The data storage 111 stores the data in column-based format. For example, the data is stored by column instead of by row, which may include the data for a column stored together rather than storing data for a row together. The data storage 111 stores the column-based multi-dimension partitioned data, which are the chunks and metadata for the chunks which identifies the data stored in each chunk. The data storage 111 may include memory for performing in-memory processing and/or non-volatile storage, such as hard disks. The query manager 124 can retrieve data on demand and restore it to its original, unmodified form. The query manager 124 may receive queries 104 and execute the queries on the data stored in the data storage 111 to provide query results 105.

The storage engine 122 performs multidimensional data partitioning of data received from the data sources 101. The data may be event data, and the event data may include time attributes comprised of Manager Receipt Time (MRT) and Event End Time (ET). Examples of dimensions include ET and MRT. MRT is when the event data is received by the data storage system 100 and ET is when the event happened. The data storage system may perform partitioning across ET and MRT simultaneously for received event data. The partitioning may include a dynamic partitioning process. The size of the partitions can be varied allowing the partitioning to be dynamic.

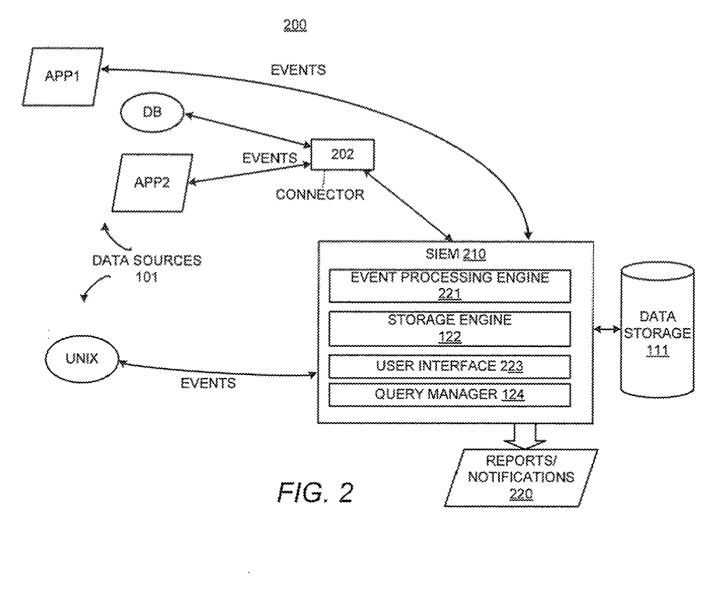

Once the event data is partitioned, the event data may be stored by column. Queries may be executed on the chunks in the column-based storage. Storing and querying event data is described in further detail below. The query manager 124 may perform operations on the results of running a query or results of running multiple queries derived from the initial query. Examples of the operations may include joins, sorts, filtering, etc., to generate a response to the initial query. The query manager 124 may provide results of the initial query to the ser for example through a user interface, such as user interface 223 shown in FIG. 2.

FIG. 2 illustrates an environment 200 including security information and event management system (SIEM) 210, according to an embodiment The SIEM 210 processes event data, which may include real-time event processing. The SIEM 210 may process the event data to determine network-related conditions, such as network security threats. Also, the SIEM 210 is described as a security information and event management system by way of example. As indicated above, the system 210 is an information and event management system, and it may perform event data processing related to network security as an example. It is operable to perform event data processing for events not related to network security. The environment 200 includes the data sources 101 generating event data for events, which are collected by the SIEM 210 and stored in the data storage 111. The data storage 111 stores any data used by the SIEM 210 to correlate and analyze event data.

The data sources 101 may include network devices, applications or other types of data sources operable to provide event data that may be analyzed. Event data may be captured in logs or messages generated by the data sources 101. For example, intrusion detection systems (IDSs), intrusion prevention systems (IPSs), vulnerability assessment tools, firewalls, anti-virus tools, anti-spam tools, encryption tools, and business applications may generate logs describing activities performed by the data source. Event data is retrieved from the logs and stored in the data storage 111. Event data may be provided, for example, by entries in a log file or a syslog server, alerts, alarms, network packets, emails, or notification pages. The data sources 101 may send messages to the SIEM 210 including event data.

Event data can include information about the source that generated the event and information describing the event. For example, the event data may identify the event as a user login or a credit card transaction. Other information in the event data may include when the event was received from the event source (“receipt time”). The receipt time may be a date/time stamp. The event data may describe the source, such as an event source is a network endpoint identifier (e.g., an IP address or Media Access Control (MAC) address) and/or a description of the source, possibly including information about the product's vendor and version. The data/time stamp, source information and other information may be columns in the event schema and may be used for correlation performed by the event processing engine 221. The event data may include metadata for the event, such as when it took place, where it took place, the user involved, etc.

Examples of the data sources 101 are shown in FIG. 1 as Database (DB), UNIX, App1 and App2. DB and UNIX are systems that include network devices, such as servers, and generate event data. App1 and App2 are applications that generate event data. App1 and App2 may be business applications, such as financial applications for credit card and stock transactions, IT applications, human resource applications, or any other type of applications.

Other examples of data sources 101 may include security detection and proxy systems, access and policy controls, core service logs and log consolidators, network hardware, encryption devices, and physical security. Examples of security detection and proxy systems include IDSs, IPSs, multipurpose security appliances, vulnerability assessment and management, anti-virus, honeypots, threat response technology, and network monitoring. Examples of access and policy control systems include access and identity management, virtual private networks (VPNs), caching engines, firewalls, and security policy management. Examples of core service logs and log consolidators include operating system logs, database audit logs, application logs, log consolidators, web server logs, and management consoles. Examples of network devices includes routers and switches. Examples of encryption devices include data security and integrity. Examples of physical security systems include card-key readers, biometrics, burglar alarms, and fire alarms. Other data sources may include data sources that are unrelated to network security.

The connector 202 may include code comprised of machine readable instructions that provide event data from a data source to the SIEM 210. The connector 202 may provide efficient, real-time (or near real-time) local event data capture and filtering from one or more of the data sources 101. The connector 202, for example, collects event data from event logs or messages. The collection of event data is shown as “EVENTS” describing event data from the data sources 101 that is sent to the SIEM 210. Connectors may not be used for all the data sources 101.

The SIEM 210 collects and analyzes the event data. Events can be cross-correlated with rules to create meta-events. Correlation includes, for example, discovering the relationships between events, inferring the significance of those relationships (e.g., by generating metaevents), prioritizing the events and meta-events, and providing a framework for taking action. The SIEM 210 (one embodiment of which is manifest as machine readable instructions executed by computer hardware such as a processor) enables aggregation, correlation, detection, and investigative tracking of activities. The SIEM 210 also supports response management, ad-hoc query resolution, reporting and replay for forensic analysis, and graphical visualization of network threats and activity.

The SIEM 210 may include modules that perform the functions described herein. Modules may include hardware and/or machine readable instructions. For example, the modules may include event processing engine 221, storage engine 122, user interface 223 and query manager 124. The event processing engine 221 processes events according to rules and instructions, which may be stored in the data storage 111. The event processing engine 221, for example, correlates events in accordance with rules, instructions and/or requests. For example, a rule indicates that multiple failed logins from the same user on different machines performed simultaneously or within a short period of time is to generate an alert to a system administrator. Another rule may indicate that two credit card transactions from the same user within the same hour, but from different countries or cities, is an indication of potential fraud. The event processing engine 221 may provide the time, location, and user correlations between multiple events when applying the rules.

The user interface 223 may be used for communicating or displaying reports or notifications 220 about events and event processing to users. The user interface 223 may also be used to select the data that will be included in each chunk, which is described in further detail with respect to FIG. 2. For example, a user may select a dimension and a distance for chunks. For example, if the dimension is ET or MRT, the distance is a time period from a seed. Depending on the distance (e.g., 5 minutes versus 10 minutes), the amount of data in a chunk may be smaller or larger. Thus, the user interface 223 may be used to select a distance from an ET or MRT which may control the amount of data in each chunk. Each chunk may be considered a partition. The user interface 223 may include a graphic user interface that may be web-based.

The storage engine 122 may perform partitioning across multiple dimensions simultaneously. For example, chunks may be determined for ET and MRT simultaneously for received event data The partitioning may include a dynamic partitioning process. The size of the partitions can be varied allowing the partitioning to be dynamic.

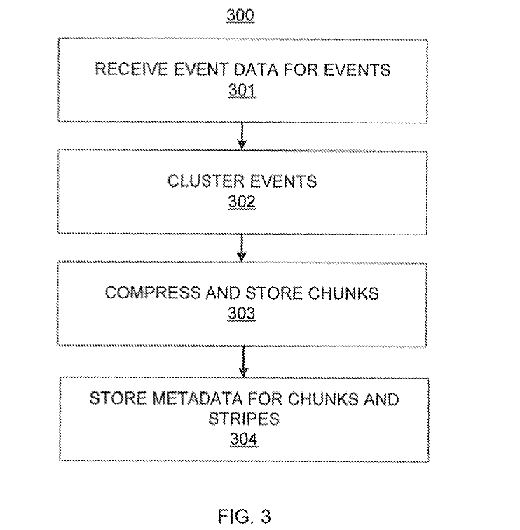

FIG. 3 illustrates a method 300 for ROS-based column storage of event data, according to an embodiment. The method 300 and other methods described herein are described with respect to the data storage system 100 shown in FIG. 1 by way of example and not limitation. The methods may be performed by other systems. Also, the methods are described with respect to event data but the methods may be used for any type of data. The method 300 may be performed by the storage engine 122 shown in FIG. 1.

At 301, event data for events is received. Event data may be received in batches from one or more of the data sources 101.

At 302, the event data is clustered across one or more dimensions to determine chunks. The clustering is a partitioning of the events. The clustering may be performed across time attributes of the events, such as ET and MRT.

For example, an event seed is selected. Any event may be selected as an event seed. For example, event data for events may be received in a batch from a data source. One of the events may be randomly selected as the seed. A distance from the seed is selected for multiple dimensions. For example, a distance is selected for ET and MRT. Distance is an amount of time from the ET and MRT for the seed. For example, a distance of 5 minutes may be selected for ET and MRT. The distance may be different or the same for the dimensions. The distance determines the amount of data in each chunk. For example, the larger the distance, the more events may fall into the cluster. Received events are split into clusters according to whether they fall into the distance from a seed. For example, if a seed has MRT and ET equal to 12:00 o'clock and a distance of 5 minutes for MRT and ET, then all events having an ET and MRT falling within the range of 12:00-12:05 are selected for a cluster of chunks. Similarly, other dusters of chunks are created for other seeds.

A chunk is created for each column. For example, an event includes an event schema including 300 columns. The columns may include ET, MRT, IP address, actor/user, source, etc. The clustering performed based on ET and MRT for a particular seed has identified 500 events. 300 chunks are created from the columns of the 500 events. All the chunks for the same cluster form a stripe. For example, a stripe includes chunks for each of the 300 columns.

At 303, the chunks are stored in compressed form. This is the column-based storage of the events.

At 304, metadata is stored identifying all the chunks in a stripe and the attributes of the stripe, such as the range of MRT and ET for the stripe. The metadata also identifies the column for each chunk. The method 300 is repeated for each set of chunks in each cluster.

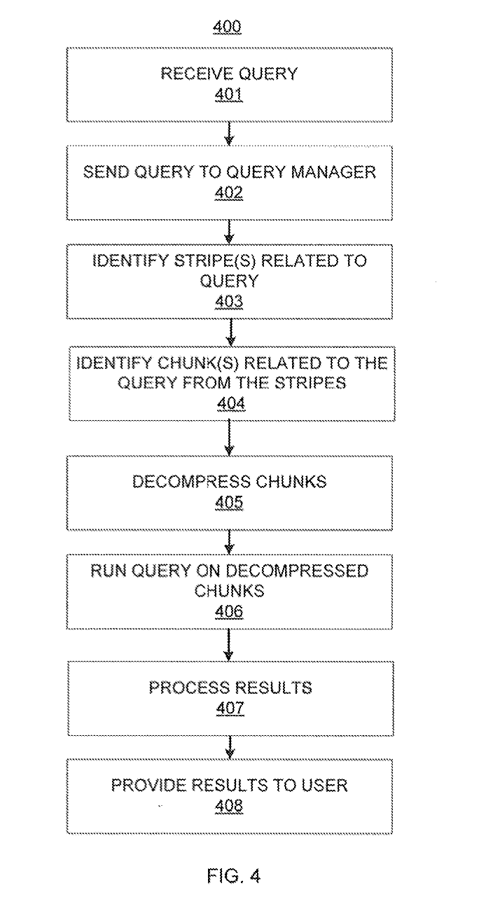

FIG. 4 illustrates a method 400 for running a query, according embodiment.

At 401, the data storage system 100 receives a query of the queries 104. The query may be from a user or another system requesting data about events stored in the data storage 111.

At 402, the data storage system 100 forwards the received query to the query manager 124 for processing.

At 403, the query manager 124 identifies one or more of the stripes related to the query. For example, the query may identify a time range for ET or MRT that specifies the events to be retrieved. The query manager 124 compares ET and/or MRT data in the query to metadata for the stripes to identify ail the stripes that may hold relevant events for the query. ET and MRT are examples of the columns that may be used to identify the relevant stripes. Other columns/fields in the query may be used to identify the relevant stripes.

At 404, the query manager 124 identifies one or more chunks from the identified stripes that correspond to columns relevant to the query.

At 405, the query manager 124 decompresses the identified chunks.

At 406, the query manager 124 executes the query (or another query derived from the query) on the decompressed chunks.

At 407, the query manager 124 may perform further processing on the results, such as joins, filtering, string searches etc., according to the data requested in the initial query.

At 408, the processed results are provided to the user for example via the user interface 223. The query results may be provided to the event processing engine 221, for example, to correlate events in accordance with rules, instructions and/or requests.

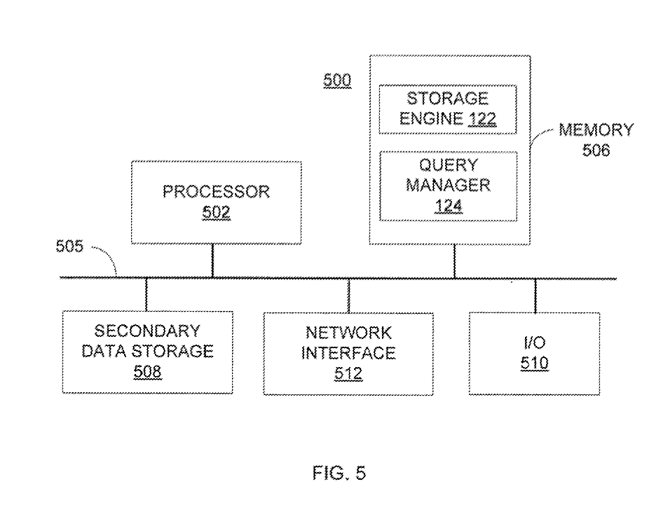

FIG. 5 shows a computer system 500 that may be used with the embodiments described herein including the data storage system 100. The computer system 500 represents a generic platform that includes components that may be in a server or another computer system. The computer system 500 may be used as a platform for the data storage system 100. The computer system 500 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 500 includes at least one processor 502 that may implement or execute machine readable instructions performing some or all of the methods, functions and other processes described herein. Commands and data from the processor 502 are communicated over a communication bus 504. The computer system 500 also includes a main memory 506, such as a random access memory (RAM), where the machine readable instructions and data for the processor 502 may reside during runtime, and a secondary data storage 508, which may be non-volatile and stores machine readable instructions and data. The storage engine 122 and the query manager 124 may comprise machine readable instructions that reside in the memory 506 during runtime. Other components of the systems described herein may be embodied as machine readable instructions that are stored in the memory 506 during runtime. The memory and data storage are examples of non-volatile computer readable mediums. The secondary data storage 508 may store data used and machine readable instructions used by the systems.

The computer system 500 may include an I/O device 510, such as a keyboard, a mouse, a display, etc. The computer system 500 may include a network interface 512 for connecting to a network. The data storage system 100 may be connected to the data sources 101 via a network and uses the network interface 512 to receive event data. Other known electronic components may be added or substituted in the computer system 500. Also, the data storage system 100 may be implemented in a distributed computing environment, such as a cloud system.

While the embodiments have been described with reference to examples, various modifications to the described embodiments may be made without departing from the scope of the claimed embodiments.

What is claimed is:

1. A data storage system comprising:
a storage engine executed by at least one processor to partition data across multiple dimensions simultaneously, to determine chunks according to the partitioning, and to perform column-based storage of the chunks, wherein each chunk represents portioned data in one column of a schema.

2. The data storage system of claim 1, wherein the storage engine is store metadata for the chunks, and the metadata identifies all chunks in a stripe for each dimension, and the stripe comprises chunks for each column in the schema.

3. The data storage system of claim 1, wherein the storage engine is to compress each chunk before storing in a data storage device.

4. The data storage system of claim 2, comprising a query manager to receive a query, and to identify stored chunks relevant to the query according to the metadata.

5. The data storage system of claim 4, wherein the query manager is to decompress the identified chunks and to execute the query on the decompressed chunks.

6. The data storage system of claim 5, wherein the query manager is to provide results of the query to an event processing engine for a security information and event management system to correlate event data to identify network security threats.

7. The data storage system of claim 5, wherein the query manager is to process results of the query by performing joins, filtering, or string searches on the results.

8. The data storage system of claim 1, wherein the data comprises event data and the schema comprises a schema for the event data including columns for different attributes of the event data.

9. The data storage system of claim wherein dimensions comprise receipt time and event end time.

10. The data storage system of claim 1, wherein the data is column-based archived.

11. The data storage system of claim 1, wherein the storage engine is to partition the data by determining a seed, determining a distance from the seed for each dimension and placing data within the distance to the seed in a chunk.

12. A security information and event management system comprising:
a storage engine executed by at least one processor to partition event data across multiple dimensions simultaneously, to determine chunks according to the partitioning, and to perform column-based storage of the chunks, wherein each chunk represents portioned data in one column of a an event schema and wherein the storage engine is to store metadata for the chunks, and the metadata identifies all chunks in a stripe for each dimension, and the stripe comprises chunks for each column in the event schema;
a query manager to receive a query, to identify stored chunks relevant. to the query according to the metadata; and execute the query on the identified chunks; and
an event processing engine to correlate some of the column-based stored event data in accordance with rules, instructions or requests to identify security threats.

13. The security information and event management system of claim 12, wherein the storage engine is to partition the data by determining a seed, determining a distance from the seed for each dimension and placing data within the distance to the seed in a chunk.

14. A non-volatile computer readable medium including machine readable instructions executable by at least one processor to:
determine dimensions to partition data across multiple dimensions simultaneously;
determine chunks for each dimension;
perform column-based storage of the chunks, wherein each chunk represents portioned data in one column of a schema for the data;
determine stripes for each partition, wherein each stripe comprises chunks for each column in the schema; and
store metadata identifying the stripes.

15. The non-volatile computer readable medium of claim 12, the machine readable instructions comprise instructions to:
receive a query;
identify stored chunks relevant the query according to the metadata;
decompress the identified chunks; and
execute the query on the decompressed chunks.
